(19) United States
(12) Patent Application Publication
(10) Pub. No.: US 2021/0041735 A1
(43) Pub. Date: Feb. 11, 2021

(54) DISPLAY PANEL AND DISPLAY DEVICE

(71) Applicant: Shenzhen China Star Optoelectronics Semiconductor Display Technology Co., Ltd., Shenzhen, Guangdong (CN)

(72) Inventor: Qi WANG, Shenzhen, Guangdong (CN)

(21) Appl. No.: 16/621,237

(22) PCT Filed: Nov. 8, 2019
(86) PCT No.: PCT/CN2019/116460

§ 371 Date: Dec. 11, 2019

(30) Foreign Application Priority Data
Aug. 8, 2019 (CN) 201910730088.5

(51) Int. Cl. G02F 1/1339; G02F 1/1335; G02F 1/1345; G02F 1/1362

(52) U.S. Cl. CPC G02F 1/13394; G02F 1/136286; G02F 1/13452; G02F 1/133514

(57) ABSTRACT

A display panel and a display device are provided. The display panel includes an array substrate, a color filter substrate, and a barrier. The array substrate is opposite to the color filter substrate. The barrier is disposed on a side of the array substrate adjacent to the color filter substrate. At least one side wall of the display panel is provided with a bonding area for bonding a driver chip, and the barrier is disposed at an edge of the array substrate adjacent to the bonding area.

### FIELD OF DISCLOSURE

The present disclosure relates to the field of display panels, and in particular to a display panel and a display device.

### BACKGROUND

At present, an ultra-narrow bezel (e.g., a width of a bezel is less than 1 mm) generally adopts a side bonding technology. The side bonding technology refers to bonding a driver chip (COF) to a side wall of a display panel (OC). In order to increase a contact between the driver chip and traces of the display panel, it is necessary to print a metal wire on the side wall of the display panel to reduce a contact resistance.

In the display panel of the prior art, the metal wire is directly printed on the side wall, and a gap between an upper and lower substrates of the display panel is large, which results in poor printing quality of the metal wire, and the contact resistance at a side bonding area is large.

### SUMMARY OF DISCLOSURE

Embodiments of the present disclosure provide a display panel and a display device to solve the problem of large side contact resistance of at a side bonding area.

An embodiment of the present disclosure provides a display panel includes an array substrate, a color filter substrate, and a barrier.

The array substrate is opposite to the color filter substrate.

The barrier is disposed on a side of the array substrate adjacent to the color filter substrate.

At least one side wall of the display panel is provided with a bonding area for bonding a driver chip, and the barrier is disposed at an edge of the array substrate adjacent to the bonding area.

Furthermore, a height of the barrier is less than a gap height between the array substrate and the color filter substrate.

In another embodiment, the barrier includes a color resist.

In another embodiment, the barrier includes a spacer.

In another embodiment, the barrier includes a color resist and a spacer which are stacked on the array substrate.

Furthermore, the at least one side wall of the display panel is in connection with a signal input line.

The bonding area is disposed on the side wall of the display panel that is in connection with the signal input line.

Furthermore, the color filter substrate is provided with a common electrode on a side adjacent to the array substrate.

Furthermore, the display panel further includes a sealing strip disposed between the array substrate and the color filter substrate. The sealing strip is disposed around a display area of the display panel.

Furthermore, the barrier is located outside of the sealing strip.

An embodiment of the present disclosure provides a display device, including a driver chip and a display panel.

The display panel display panel includes an array substrate, a color filter substrate, and a barrier.

The array substrate is opposite to the color filter substrate.

The barrier is disposed on a side of the array substrate adjacent to the color filter substrate.

At least one side wall of the display panel is provided with a bonding area for bonding a driver chip, the barrier is disposed at an edge of the array substrate adjacent to the bonding area, and the driver chip is bound to the bonding area of the display panel.

A height of the barrier is less than a gap height between the array substrate and the color filter substrate.

Furthermore, the barrier includes a color resist.

Furthermore, the barrier includes a spacer.

Furthermore, the barrier includes a color resist and a spacer which are stacked on the array substrate.

Furthermore, the at least one side wall of the display panel is in connection with a signal input line.

The bonding area is disposed on the side wall of the display panel that is in connection with the signal input line.

Furthermore, the color filter substrate is provided with a common electrode on a side adjacent to the array substrate.

Furthermore, the display device further includes a sealing strip disposed between the array substrate and the color filter substrate.

The sealing strip is disposed around a display area of the display panel.

Furthermore, the barrier is located outside of the sealing strip.

Advantages of the present disclosure are as follow. The barrier is disposed on a side of the array substrate adjacent to the color filter substrate, and the barrier is disposed at an edge of the array substrate adjacent to the bonding area, so that the gap between the array substrate and the color filter substrate at a bonding area is reduced. It is beneficial to improve a quality of an edge grinding, improve a printing quality of a metal wire at the bonding area, thereby reducing a contact resistance at a side bonding area, and improving an image quality of the display panel with an ultra-narrow bezel.

### BRIEF DESCRIPTION OF DRAWINGS

In order to illustrate the technical proposal of implementations of the embodiments of the present disclosure or existing technology clearly, With reference to said accompanying drawings, the description of the implementations of the present disclosure or existing technology are given as following briefly. Obviously, the given accompanying drawings are only implementations of the present disclosure, so that, the ordinary technicians in this field could get other accompanying drawings in accordance with said accompanying drawings without devoting creative efforts.

FIG. 1 is a schematic diagram of a display panel of an embodiment of the present disclosure.

FIG. 2 is a cross-sectional view of the display panel of the embodiment of the present disclosure.

FIG. 3 is a schematic diagram of a display panel of another embodiment of the present disclosure.

### DETAILED DESCRIPTION

Preferred embodiments of the present disclosure will be described below with referring to the appending drawings to prove that the present disclosure is implementable. These embodiments are described for illustrations of the present disclosure for a person skilled in the art and make the technical schemes more clear and be easily understood. The present disclosure may be carried out by various embodiments constructed in different forms and the scope to be protected in the present disclosure is not limited to the embodiments just described in the context.

Terms used in the description of the present disclosure are only used to describe particular embodiments, and are not intended to show a concept of the present disclosure. Expressions used in the singular encompass the plural form of expression unless the context clearly dictates. In the present disclosure, it is to be understood that terms such as “including”, “having”, and “comprising” are intended to indicate the presence of the features, numbers, steps, acts, or combinations thereof disclosed in the present disclosure. It is not intended to exclude the possibility that one or more other features, numbers, steps, acts, or combinations thereof may be added. The same reference numerals in the drawings denote the same parts.

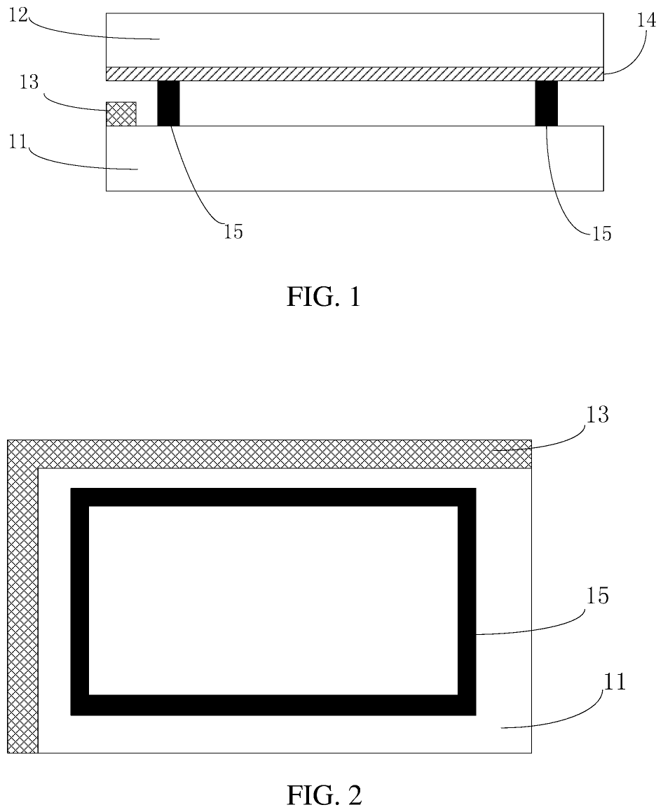

Referring to FIG. 1, which is a schematic diagram of a display panel of an embodiment of the present disclosure.

The display panel of the embodiment of the present disclosure includes an array substrate 11, a color filter substrate 12, and a barrier 13. The array substrate 11 is opposite to the color filter substrate 12. The barrier 13 is disposed on a side of the array substrate 11 adjacent to the color filter substrate 12.

The display panel includes a display area and a non-display area. The display area of the display panel includes a display area of the array substrate 11 and a display area of the color filter substrate 12. The display area of the array substrate 11 is opposite to the display area of the color filter substrate 12. The non-display area of the display panel includes a non-display area of the array substrate 11 and a non-display area of the color filter substrate 12. The non-display area of the array substrate 11 is opposite to the non-display area of the color filter substrate 12. The barrier 13 is provided at the non-display area of the array substrate 11. There is a gap between the barrier 13 and the color filter substrate 12, that is, the height of the barrier 13 is less than a gap height between the array substrate 11 and the color filter substrate 12.

At least one side wall of the display panel is provided with a bonding area (not shown) for binding an external driver chip. A side surface of the array substrate 11 is flush with a side surface of the color filter substrate 12 such that the bonding area is provided on the same side walls of the array substrate 11 and the color filter substrate 12. A metal wire such as an Ag wire is printed in the bonding area. The driver chip is electrically connected to the display panel through the metal wire to realize bonding of the driver chip and the display panel.

The barrier 13 is disposed at an edge of the array substrate 11 adjacent to the bonding area. Specifically, as shown in FIG. 2, the barrier 13 is disposed near a boundary of the array substrate 11, and the boundary is adjacent to the bonding area of the array substrate 11. In this embodiment, by adding the barrier 13, the gap between the array substrate 11 and the color filter substrate 12 at a binding area is reduced, which is beneficial to improve a quality of an edge grinding, improve a printing quality of a metal wire at the bonding area, thereby reducing a contact resistance at a side bonding area.

In a specific embodiment, the barrier 13 includes a color resist. The color resist may be a red color resist, a blue color resist, or a green color resist, or may be other color resist, and is not specifically limited herein. A height of the color resist is less than the gap height between the array substrate 11 and the color filter substrate 12.

In another specific embodiment, the barrier 13 includes a spacer (PS). A height of the spacer is less than the gap height between the array substrate 11 and the color filter substrate 12.

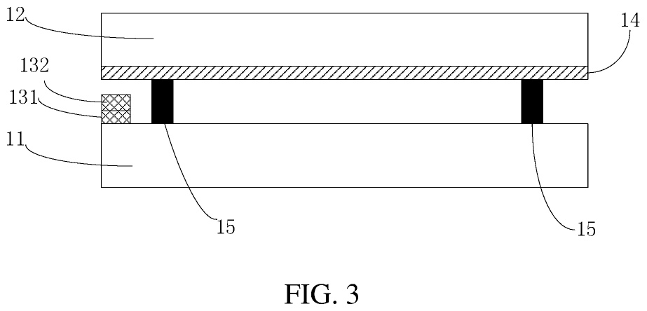

In another specific embodiment, as shown in FIG. 3, a barrier 13 includes a color resist 131 and a spacer 132 which are stacked with each other. The color resist 131 is disposed on a side of an array substrate 11 adjacent to a color filter substrate 12, and the spacer 132 is disposed on the color resist 131 adjacent to the color filter substrate 12. A height of the color resist 131 and the spacer 132 is less than a gap height between the array substrate 11 and the color filter substrate 12.

Furthermore, at least one side wall of the display panel is in connection with a signal input line. A bonding area is disposed on the side wall of the display panel that is in connection with the signal input line.

It should be noted that an electrode is disposed on the array substrate 11. The signal input line connected to the side wall of the display panel is electrically connected to the electrode of the array substrate 11. A bonding area is set on the side wall connected to the signal input line of the display panel, so that a metal wire in the bonding area is electrically connected to the signal input line, and a driver chip and the display panel are bound.

As shown in FIG. 2, two adjacent side walls of the display panel are connected with the signal input line, and the two side walls of the display panel are provided with the bonding area. The barrier 13 is disposed at edges of the array substrate 11 adjacent to the two side walls to reduce the gap between the array substrate 11 and the color filter substrate 12 at the binding area.

Furthermore, a sealing strip 15 is further disposed between the array substrate 11 and the color filter substrate 12. The sealing strip 15 is disposed around the display area of the display panel.

As shown in FIG. 2, the sealing strip 15 is disposed on a periphery of the display area AA of the array substrate 11 and the display area of the color filter substrate 12. The sealing strip 15 may be a sealant for attaching the array substrate 11 and the color filter substrate 12 to encapsulate the display area of the display panel.

As shown in FIG. 2, the barrier 13 is located outside the sealing strip 15, that is, the barrier 13 is located between the sealing strip 15 and the edge of the array substrate 11. A width of the barrier 13 on the array substrate 11 can be determined according to a bezel size of the display panel and an accuracy of a process.

Furthermore, as shown in FIG. 1, a common electrode 14 is disposed on a side of the color filter substrate 12 adjacent to the array substrate 11.

It should be noted that the display panel of the display panel is also encapsulated with liquid crystal. The common electrode 14 on the color filter substrate 12 has a potential difference from electrodes on the array substrate 11 to form an electric field. The liquid crystal is deflected by an influence of the electric field to display an image.

It can be seen from the above that in the display panel of these embodiments, the barrier is disposed on a side of the array substrate adjacent to the color filter substrate, and the barrier is disposed at an edge of the array substrate adjacent to the bonding area, so that the gap between the array substrate and the color filter substrate at a bonding area is reduced. It is beneficial to improve a quality of an edge grinding, improve a printing quality of a metal wire at the bonding area, thereby reducing a contact resistance at a side bonding area, and improving an image quality of the display panel with an ultra-narrow bezel.

An embodiment of the present disclosure also provides a display device, including a driver chip and a display panel. The driver chip is bound to a bonding area of the display panel. The display panel is as described in the foregoing embodiments, and details are not described herein again.

The display device of this embodiment can improve a printing quality of a metal wire at the bonding area, thereby reducing a contact resistance at a side bonding area, and improving an image quality of the display panel with an ultra-narrow bezel.

In summary, although the preferable embodiments of the present disclosure have been disclosed above, the embodiments are not intended to limit the present disclosure. A person of ordinary skill in the art, without departing from the spirit and scope of the present disclosure, can make various modifications and variations. Therefore, the scope of the disclosure is defined in the claims.

What is claimed is:

1. A display panel, comprising:
an array substrate and a color filter substrate opposite to the array substrate; and
a barrier disposed on a side of the array substrate adjacent to the color filter substrate, wherein at least one side wall of the display panel is provided with a bonding area for bonding a driver chip, and the barrier is disposed at an edge of the array substrate adjacent to the bonding area.

2. The display panel as claimed in claim 1, wherein a height of the barrier is less than a gap height between the array substrate and the color filter substrate.

3. The display panel as claimed in claim 1, wherein the barrier comprises a color resist.

4. The display panel as claimed in claim 1, wherein the barrier comprises a spacer.

5. The display panel as claimed in claim 1, wherein the barrier comprises a color resist and a spacer which are stacked on the array substrate.

6. The display panel as claimed in claim 1, wherein the at least one side wall of the display panel is in connection with a signal input line; and
the bonding area is disposed on the side wall of the display panel that is in connection with the signal input line.

7. The display panel as claimed in claim 1, wherein the color filter substrate is provided with a common electrode on a side adjacent to the array substrate.

8. The display panel as claimed in claim 1, further comprising a sealing strip disposed between the array substrate and the color filter substrate, wherein the sealing strip is disposed around a display area of the display panel.

9. The display panel as claimed in claim 8, wherein the barrier is located outside of the sealing strip.

10. A display device, comprising a driver chip and a display panel, wherein the display panel comprises:
an array substrate and a color filter substrate opposite to the array substrate; and
a barrier disposed on a side of the array substrate adjacent to the color filter substrate, wherein at least one side wall of the display panel is provided with a bonding area for bonding a driver chip, the barrier is disposed at an edge of the array substrate adjacent to the bonding area, and the driver chip is bound to the bonding area of the display panel.

11. The display device as claimed in claim 10, wherein a height of the barrier is less than a gap height between the array substrate and the color filter substrate.

12. The display device as claimed in claim 10, wherein the barrier comprises a color resist.

13. The display device as claimed in claim 10, wherein the barrier comprises a spacer.

14. The display device as claimed in claim 10, wherein the barrier comprises a color resist and a spacer which are stacked on the array substrate.

15. The display device as claimed in claim 10, wherein the at least one side wall of the display panel is in connection with a signal input line; and
the bonding area is disposed on the side wall of the display panel that is in connection with the signal input line.

16. The display device as claimed in claim 10, wherein the color filter substrate is provided with a common electrode on a side adjacent to the array substrate.

17. The display device as claimed in claim 10, further comprising a sealing strip disposed between the array substrate and the color filter substrate, wherein the sealing strip is disposed around a display area of the display panel.

18. The display device as claimed in claim 17, wherein the barrier is located outside of the sealing strip.
